(19) United States
(12) Patent Application Publication
(10) Pub. No.: US 2009/0245841 A1
(43) Pub. Date: Oct. 1, 2009

(54) Fixing Device and Image Forming Apparatus

(75) Inventor: Yuichi SEGAWA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/405,591

(22) Filed: Mar. 17, 2009

(30) Foreign Application Priority Data
Mar. 27, 2008 (JP) 2008-082279

(51) Int. Cl. G03G 15/20

(52) U.S. Cl. 399/69

(57) ABSTRACT

A fixing device including a heating belt stretched over heating and fixing rollers is rotated to fix a toner image of a transfer material. A first mode combines heating and rotation stop of the heating belt. A second mode combines heating and rotation of the heating belt. When returning the heating belt for an image forming operation from a non-heating and non-rotation state, the heating belt is controlled by the first mode and then transitioned to the second mode when the heating belt temperature equals or exceeds a predetermined mode transition reference temperature. At the start of the transition to the second mode, the rotation speed of the heating belt is controlled such that a temperature difference between a winding portion of the heating belt that is wound on the heating roller and a non-winding portion that is not wound on the heating roller is decreased.

### BACKGROUND

1. Technical Field

The present invention relates to a fixing device which is used in formation of an electrophotographic image and performs fixing by a heating belt, and an image forming apparatus including the same.

2. Related Art

A belt-fixing type fixing device is known as a fixing device of an image forming apparatus. This belt-fixing type fixing device includes an endless heating belt and a pressurization roller. The heating belt is stretched over a fixing roller and a heating roller with tension. A toner image of a transfer material is heated and pressurized at a nip portion (pressing portion) of the heating belt and the pressurization roller so as to be fixed on the transfer material.

However, in the belt-fixing type fixing device, a fixing belt stretched over a pair of rollers may be skewed and thus the fixing belt may be damaged. Accordingly, a fixing device which suppresses the bias of the fixing belt by guide rings provided at both ends of the heating roller so as to prevent the skew of the fixing belt is suggested (for example, see Japanese Patent No. 3711717). In the fixing device disclosed in Japanese Patent No. 3711717, a vertical surface and an inclined surface are provided in the wall surfaces of the guide rings facing the fixing belt. By the vertical surfaces of the guide rings, the bias of the fixing belt is suppressed. In addition, when the fixing belt rides over the inclined surface by the skew, the fixing belt is prevented from riding over the inclined surface.

Generally, the heating roller is formed of, for example, a metal material such as aluminum, in view of strength and heat transfer to the heating belt. In addition, the heating belt is formed of a thin flexible belt obtained by coating a belt base material such as nickel with silicon rubber or the like. Accordingly, a thermal expansion coefficient of the heating roller is relatively large and a thermal expansion coefficient of the heating belt is relatively small.

In addition, when a power source of the heating roller is turned off, the belt has a low temperature. However, when the power source of the image forming apparatus is switched from an OFF state to an ON state or an image forming command is generated from a slip mode (power saving mode), a belt heating operation and a belt rotation operation are substantially simultaneously started.

However, when the image forming apparatus is set to the above-described mode after the heating belt is heated by an image forming operation, the heating belt and the heating roller are cooled. At this time, a heat contraction amount of the heating roller in an axial direction becomes larger than that of the heating belt in a width direction. Then, as shown in FIG. 12, a guide ring b of a heating roller a strongly presses a belt edge d of a heating belt c with force Ft. In this case, a central portion of a width direction of the heating belt c cannot easily slide in the width direction due to friction with the heating roller (not shown). Accordingly, large stress is applied to an end (an area of the belt close to the belt edge in the width direction) of the heating belt c and several wrinkles e (waving of irregularities) are generated in the heating belt c in the width direction of the belt.

If an image forming command is generated in a state in which the wrinkles e are generated, the belt heating operation and the belt rotation operation are substantially simultaneously started as described above. Then, since the edge d of the belt portion entering the heating roller a is continuously pressed by the guide ring b in the width direction and the wrinkles e are moved, adjacent concave portions overlap with each other and crack occurs in the heating belt c.

### SUMMARY

An advantage of some aspects of the invention is that it provides a fixing device and an image forming apparatus capable of suppressing crack from occurring in a heating belt at the time of returning for an image forming operation from a belt temperature state lower than a belt control temperature during the image forming operation.

According to a fixing device of the invention, at the time of the returning of a heating belt for an image forming operation from a low belt temperature state of the heating belt due to the OFF state of a power source of a heating roller in a power source off state or a slip mode (power saving mode), two modes are set with respect to the heating control and the rotation control of the heating belt. The first mode is a combination mode of the heating of the heating belt and the rotation stop of the heating belt. The second mode is a combination mode of the heating of the heating belt and the rotation of the heating belt.

Accordingly, at the time of the returning of the heating belt, the heating belt is first heated by the setting of the first mode, but the heating belt is not rotated. Next, when the surface temperature of the heating belt is increased to a mode transition reference temperature, the heating of the heating belt is continuously performed and the heating belt is rotated, by the setting of the second mode. At this time, wrinkles of the heating belt disappear. Accordingly, the bias of the heating belt entering the heating roller can be suppressed by a bias preventing unit. In addition, although the bias preventing unit presses an edge of a belt portion of the heating belt in a width direction, since the wrinkles are not present in the heating belt, it is possible to prevent the generation of crack in the heating belt. Accordingly, it is possible to adequately perform the heating, the pressurization and fixing using the fixing device over a long period of time.

At the time of the start of the transition to the second mode, a rotation speed of the heating belt is controlled such that a temperature difference between a winding portion of the heating belt which is wound on the heating roller and a non-winding portion of the heating belt which is not wound on the heating roller in the first mode is decreased. Accordingly, the protrusion amount (width step difference) of a side edge of the winding portion in the width direction of the heating belt can be decreased. Therefore, although the heating belt is rotated by the second mode, the pressing force of the width direction of the heating belt due to the bias preventing unit can be decreased. As a result, the heating belt can be smoothly rotated, the damage of the side edge of the winding portion due to the bias preventing unit can be suppressed, and the generation of the crack of the heating belt can be efficiently prevented. Accordingly, the long life span of the heating belt can be efficiently realized.

According to an image forming apparatus including the fixing device of the invention, since the heating, the pressurization, and the fixing can be adequately performed, it is possible to form an image with high quality over a long period of time.

### BRIEF DESCRIPTION OF THE DRAWINGS

The invention will be described with reference to the accompanying drawings, wherein like numbers reference like elements.

FIG. 1 is a schematic view of an example of an image forming apparatus according to an embodiment of the invention.

FIG. 2 is a schematic view of a fixing device of the example shown in FIG. 1.

FIG. 3A is a partial front view of the fixing device, FIG. 3B is a right side view thereof, FIG. 3C is a cross-sectional view taken along IIIC-IIIC of FIG. 3B, and FIG. 3D is a partial top view thereof.

FIG. 4A is a view showing a heating belt state during non-heating and non-rotation and FIG. 4B is a view showing the heating belt state after heating in a first mode.

FIG. 5A is a view explaining a temperature difference between a winding portion and a non-winding portion of the heating belt in a first mode, FIG. 5B is a schematic view of the left side of FIG. 5A, FIG. 5C is a view explaining substantial one rotation of the heating belt when a second mode is started, FIG. 5D is a schematic view of the right side of FIG. 5C, FIG. 5E is a view explaining the behavior during one rotation of the heating belt in the second mode, and FIG. 5F is a schematic view of the right side of FIG. 5E.

FIG. 6 is a view showing a temperature difference between the winding portion and the non-winding portion in each of the modes.

FIGS. 7A to 7C are views showing one rotation of the heating belt.

FIG. 8 is a view showing an example in which an average rotation speed of the heating belt is set to be lower than a general rotation speed.

FIG. 9 is a view showing another example in which the average rotation speed of the heating belt is set to be lower than the general rotation speed.

FIG. 10 is a view showing another example in which the average rotation speed of the heating belt is set to be lower than the general rotation speed.

FIG. 11 is a block diagram showing an example of a control device of the fixing device of the example shown in FIG. 2.

FIG. 12 is a view explaining a problem of a heating belt of the related art.

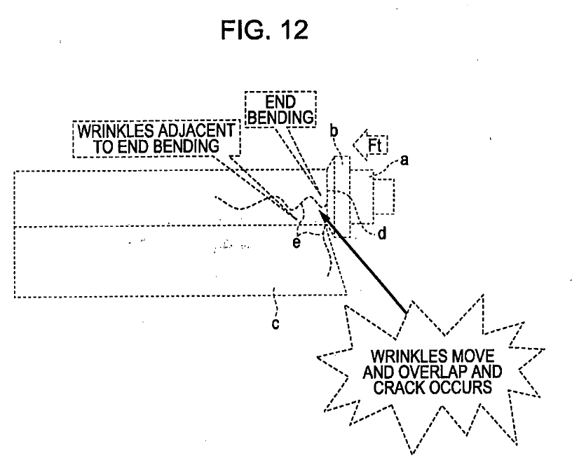

### DESCRIPTION OF EXEMPLARY EMBODIMENTS

Hereinafter, the embodiment of the invention will be described with reference to the accompanying drawings.

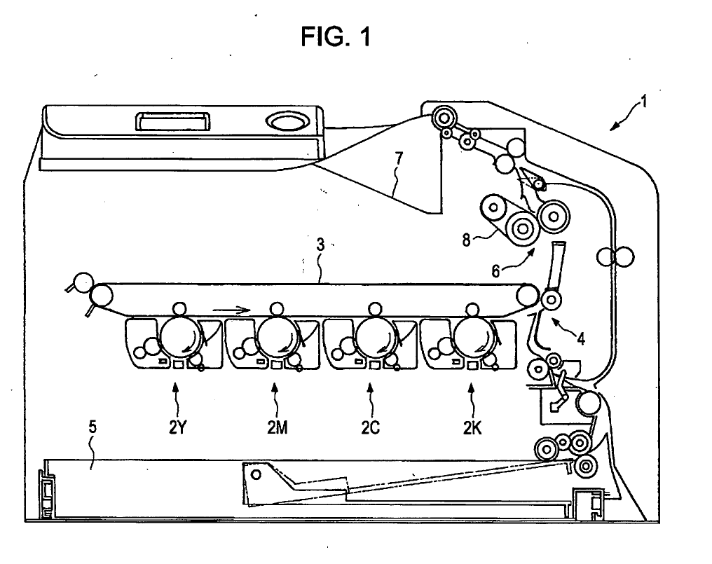

FIG. 1 is a schematic view of an example of an image forming apparatus according to an embodiment of the invention.

As shown in FIG. 1, the image forming apparatus 1 of this example includes image forming stations 2Y, 2M, 2C and 2K of respective colors of yellow (Y), magenta (M), cyan (C) and black (K). In addition, an endless intermediate transfer belt 3 is rotatably provided in a counter-clockwise direction in FIG. 1. The image forming stations 2Y, 2M, 2C and 2K are arranged in tandem along a movement direction of a portion of the intermediate transfer belt 3 facing the image forming stations. In addition, the arrangement order of the image forming stations of the respective colors is arbitrarily set, but, in the following description, the arrangement order shown in FIG. 1 is used. The image forming stations 2Y, 2M, 2C and 2K transfer toner images of the colors corresponding thereto on a transfer belt 3 which is a transfer belt.

A transfer device 4 is provided in the vicinity of the image forming station 2K. This transfer device 4 transfers the toner image on the transfer belt 3 on a transfer material (not shown) transported from a transfer material storage device 5 of the transfer material such as paper. In addition, a fixing device 6 is provided in the vicinity of the transfer device 4. This fixing device 6 fixes the toner image on the transfer material by, for example, heating, pressurization, and fixing. The transfer material on which the image is formed is received in an ejected transfer material tray 7. In addition, in this image forming apparatus 1, the detailed configurations and the detailed operations of the image forming stations 2Y, 2M, 2C and 2K, the intermediate transfer belt 3, the transfer device 4, the transfer material storage device 5, the fixing device 6, and the ejected transfer material tray 7 are known and can be understood by referring to, for example, Japanese Patent No. 3711717 and JP-A-2008-15164 (a fixing device described in JP-A-2008-15164 is different in view of a pressurization belt), the detailed description thereof will be omitted.

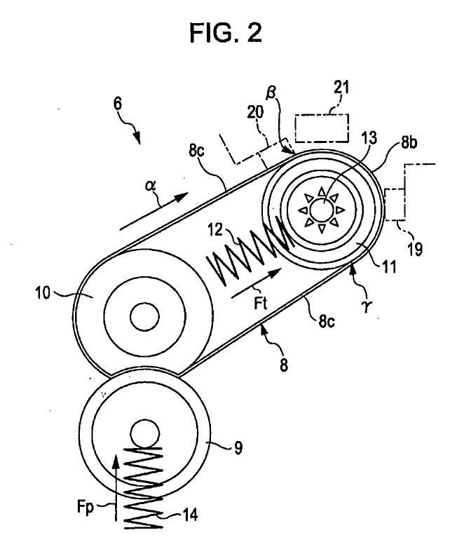

As shown in FIG. 2, the fixing device 6 includes an endless heating belt 8 and a pressurization roller 9. The heating belt 8 is stretched between a fixing roller 10, to which driving force is delivered by a driving unit such as a motor (not shown) or the like, and a heating roller 11. In this case, predetermined tension is applied to the heating belt 8 by spring force Ft of a tension applying spring 12. The heating roller 11 is formed in a cylindrical shape, and includes a heater 13 provided therein, such as a halogen heater lamp or the like. A power source (not shown) of the heater 13 is turned on such that the heating belt 8 is heated by the heat generated by the heater 13 via the heating roller 11.

The pressurization roller 9 is pressed on the heating belt 8 stretched over the fixing roller 10 by predetermined pressing force due to the spring force Fp of a pressurization spring 14. In this case, since the fixing roller 10 and the heating belt 8 are softer than the pressurization roller 9, in a nip portion (pressing portion) between the pressurization roller 9 and the heating belt 8, the fixing roller 10 and the heating belt 8 are recessed. A transfer material, on which a toner image is transferred, passes through the nip portion of the heating belt 8 and the pressurization roller 9, which are rotated in a rotation direction a and are heated, in a state of being heated and pressed such that toner image is fixed on the transfer material.

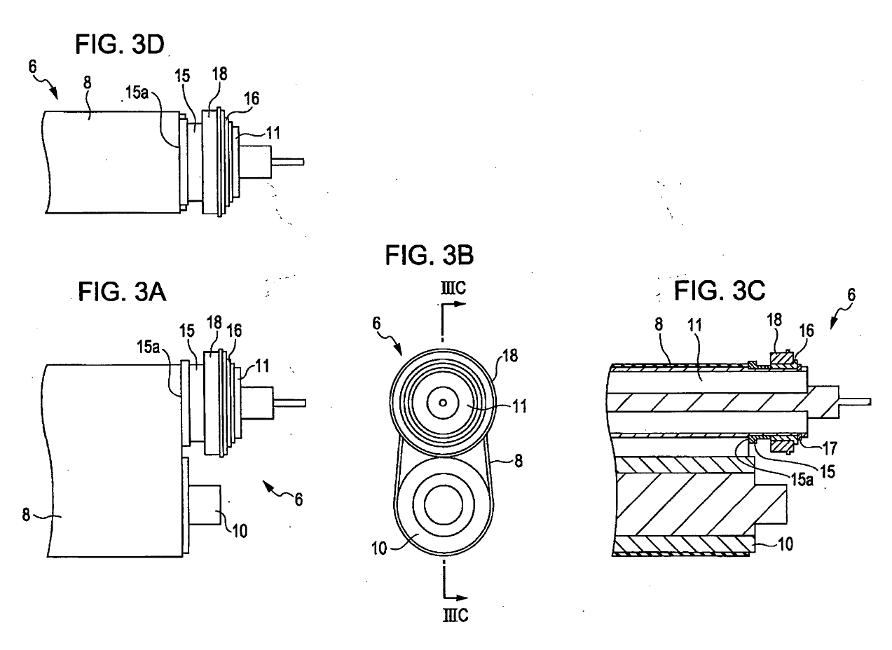

As shown in FIGS. 3A to 3D, a guide ring 15 (corresponding to a bias preventing unit of the invention) having a guide surface is a in one edge thereof is provided on the heating roller 11. This guide ring 15 is wound on the outer circumferential surface of the heating roller 11 and the guide surface 15a is in contact with the edge of the heating belt 8 so as to prevent the bias of the heating belt 8. In addition, a heat insulating bush 16 is wound on the outer circumferential surface of the heating roller 11 in a state of being in contact with an edge of the guide ring 15 on the side opposite to the guide surface 15a. An edge of the heat insulating bush 16 on the side opposite to the guide ring 15 is axially fixed by a locking ring 17 fixed to the heating roller 11. By this configuration, the guide ring 15 and the heat insulating bush 16 are axially positioned with respect to the heating roller 11. In addition, the heat insulating bush 16 is rotatably and movably supported on a frame (not shown) of the fixing device 6 in a direction along a line of action of the spring force Ft of the tension applying spring 12, with a bearing 18 interposed therebetween.

In addition, although only the guide ring 15 of one end side of the heating roller 11 is shown in FIGS. 3A to 3D, the same guide ring 15 is provided on the other end side of the heating roller 11. In this case, the guide ring 15 of the other end side of the heating roller 11 passes through the center of the heating roller 11 in an axial direction and is symmetrically provided with respect to a straight line (not shown) perpendicular to the axial direction. Although not shown, the fixing roller 10 is rotatably supported on the frame of the fixing device 6 with the bearing interposed therebetween. Although not shown, the pressurization roller 9 is rotatably and movably supported on the frame of the fixing device 6 in a direction along a line of action of the spring force Fp of the pressurization spring 14, with the bearing interposed therebetween.

First belt temperature detecting devices (for example, a thermistor or the like) 19 are provided in a state of being in contact with or in the vicinity of the heating belt 8 stretched over the heating roller 11. These first belt temperature detecting devices 19 detect the surface temperature of a portion of the heating belt 8 and send the surface temperature to a control device (not shown) of the image forming apparatus. The control device controls the ON/OFF of the heater 13 on the basis of the temperature of the heating belt 8 detected by the first belt temperature detecting devices 19 such that the temperature of the heating belt 8 is held at a desired temperature during an image forming operation. Transition from a first mode to a second mode is controlled on the basis of the temperature of the heating belt 8 detected by the first belt temperature detecting devices 19.

Second belt temperature detection devices (for example, a thermistor or the like) 20 are provided in a state of being in contact with or in the vicinity of the heating belt 8 anterior to a contact start position D which is in contact with the heating roller 11. In this case, although not shown, the second belt temperature detection devices 20 are arranged at two places. That is, the second belt temperature detection devices 20 are arranged at positions corresponding to a central portion of the heating belt 8 in a width direction and any one end of both ends of the heating belt 8 in the width direction. These second belt temperature detection devices 20 detect the surface temperature of the heating belt 8 immediately before being brought into contact with the heating roller 11 and send the surface temperature to the control device of the image forming apparatus. The control device calculates a mode transition reference temperature T_{bs} (° C.) on the basis of a higher temperature of the temperatures of the heating belt 8 detected by the two second belt temperature detection devices 20. In addition, as the temperature of the heating belt 8, the temperature of the portion of the heating belt 8 wound on the heating roller 11, which is detected by the first belt temperature detection devices 19, as well as the temperatures detected by the second belt temperature detection devices 20 may be used. In this case, the two first belt temperature detection devices 19 are arranged on the central portion of the heating belt 8 and any one end of both ends of the heating belt 8 in the width direction, as described above. The first belt temperature detection devices 19 and the second belt temperature detection devices 20 may be arranged at positions which become the same phase with respect to the rotation direction of the heating belt 8. In this case, the first belt temperature detection devices 19 are arranged on the central portion of the heating belt 8 in the width direction, and the second belt temperature detection devices 20 are arranged on any one end of both ends of the heating belt 8 in the width direction.

A third belt temperature detection device (for example, a thermostat or the like) 21 is arranged on the side of the first belt temperature detection devices 19 rather than the second belt temperature detection devices 20 toward the rotation direction a of the heating belt 8. This third belt temperature detection device 21 is provided in the vicinity of the heating belt 8 so as to detect the surface temperature of the heating belt 8. The third belt temperature detection device 21 turns off the power source of the heater 13 when the temperature of the heating belt 8 (that is, the temperatures of the heating roller 11 and the heater 13) becomes abnormally a high temperature by an unexpected situation. Accordingly, it is possible to prevent the adverse effect due to the abnormal increase of the temperature of the heating belt 8 (that is, the temperatures of the heating roller 11 and the heater 13) (high-temperature destroy or the like of the heating roller 11 or the heating belt 8).

In the fixing device 6 of this example, at the time of returning from a power source off state or a slip mode, in which the power source of the heating belt 8 is turned off, the rotation of the heating belt 8 is stopped, and the belt temperature becomes a low temperature (during the non-heating and the non-rotation of the heating belt 8), to the image formation, two next modes, that is, first and second modes, are set with respect to the control of a belt heating operation and a belt rotation operation of the heating belt 8. That is, the first mode is a combination mode of the heating of the heating roller 11 and the driving stop of the fixing roller 10 (that is, the rotation stop of the heating belt 8. The second mode is a combination mode of the heating mode of the heating roller 11 and the driving of the fixing roller 10 (that is, the rotation of the heating belt 8).

At the time of returning from the power source off state or the slip mode, the control device of the image forming apparatus 1 first performs the heating control of the heating roller 11 and the driving control of the heating belt 8 using a driving unit by the first mode. That is, the heating roller 11 is heated and the driving of the heating belt 8 is stopped. Thereafter, the control device transitions from the first mode to the second mode and performs the control by the second mode. That is, the heating of the heating roller 11 is continuously performed and the heating belt 8 is driven. In this case, the control device performs the transition from the first mode to the second mode on the basis of the surface temperature of the heating belt 8 immediately before being brought into contact with the heating roller 11, which is detected by the second belt temperature detection devices 20.

At this time, a transition temperature from the first mode to the second mode (that is, the mode transition reference temperature T_{bs} (° C.) in which the heating belt 8 is rotated) is set to satisfy Equation 1 (that is, Equation 2) and Equation 3. This mode transition reference temperature T_{bs} (° C.) is the temperature of the heating belt 8 in which the wrinkles of the heating belt 8 generated by the low temperature state of the belt due to the power source off state or the slip mode disappear or substantially disappear.

L×(T_{b}−Tᵣ)×αₕᵣ−L×(T_{b}−Tᵣ)×α_{b}≦L×(T_{bs}−Tᵣ)×2×αₕᵣ−L×(T_{bs}−Tᵣ)×α_{b} Equation 1

where,
L: Width of the heating belt and width (mm) between the guide rings of the heating roller,
T_{b}: Belt control temperature (° C.) of the heating belt,
Tᵣ: Environment temperature (° C.) (for example, a room temperature or the like, and, as a detailed value, for example 20° C.),
T_{bs}: Mode transition temperature (° C.) of the heating belt during the transition from the first mode to the second mode,
αₕᵣ: Linear expansion coefficient (1/° C.) of the heating roller, and
α_{b}: Linear expansion coefficient (1/° C.) of the heating belt.

When Equation 1 is changed with respect to the mode transition reference temperature T_{bs},

$$\begin{matrix}\frac{( {α}_{hr} - {α}_{b} ) {T}_{b} + {α}_{hr} {T}_{r}}{2 {α}_{hr} - {α}_{b}} \leq {T}_{bs} & Equation 2 \\ {T}_{bs} < {T}_{0} & Equation 3\end{matrix}$$

where,
T₀: Destroy temperature (° C.) of the heating belt.

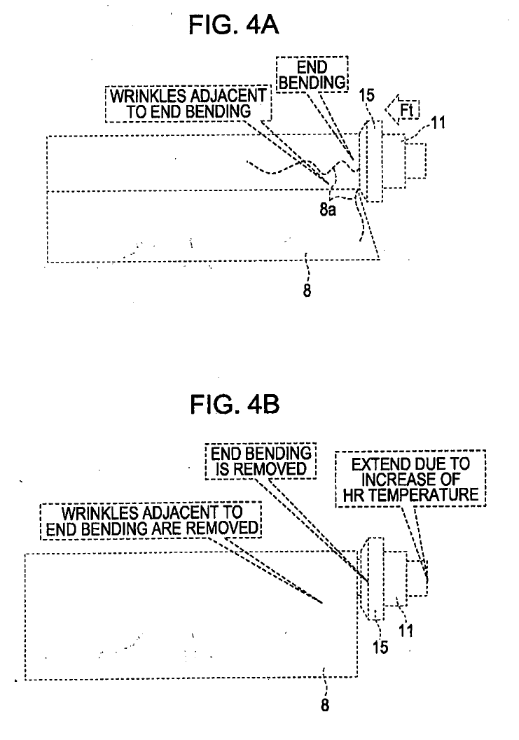

In Equation 1, the mode transition reference temperature T_{bs} is set as follows. That is, at the time of the power source off state or the slip mode, in the low temperature state, since the contraction amount of the heating roller 11 in the axial direction is larger that of the heating belt 8 in the width direction as described above, wrinkles are generated in the heating belt 8 shown in FIG. 4A due to several concave portions 8a. At this time, the temperatures of the heating belt 8 and the heating roller 11 are substantially equal. In this state, when the fixing device 6 is returned to the power source off state or the slip mode by an image forming command or the like, the heating roller 11 is heated. Accordingly, the heating belt 8 is heated by the first mode and the temperature thereof is increased. At this time, since the heating roller 11 is heated earlier than the heating belt 8, the temperature of the heating roller 11 becomes higher than the temperature of the heating belt 8 (that is, the temperature of the heating belt 8 detected by the second belt temperature detection devices 20) in the first mode. In this case, as the experiment results of the temperature measure, in the first mode, the temperature of the heating roller 11 becomes about twice of the temperature of the heating belt 8.

When the temperature of the heating belt 8 becomes the mode transition reference temperature T_{bs}, it is considered that the temperature of the heating roller 11 is about twice of the mode transition reference temperature T_{bs}. When the temperature of the heating belt 8 becomes the mode transition reference temperature T_{bs}, since the expansion amount of the heating roller 11 in the axial direction is large than that of the heating belt 8 in the width direction, the wrinkles in the heating belt 8 shown in FIG. 4B due to the concave portions 8a disappear. That is, the mode transition reference temperature T_{bs} is a temperature in which the wrinkles in the heating belt 8 due to the concave portions 8a disappear by the heating of the heating roller 11 in the first mode.

In Equation 3, the mode transition reference temperature T_{bs} is set to lower than the belt destroy temperature T₀ (° C.). This belt destroy temperature T₀ (° C.) is given as a measured value. That is, By performing a belt heating destroy experiment in a temperature range including a temperature area derived using the heating belt 8, the fixing roller 10 and the heating roller 11 used in the fixing device 6, the belt destroy temperature T₀ (° C.) is set. As a detailed example, the fixing device 6 is solely set or the fixing device 6 is set in the image forming apparatus 1 in a state in which the temperature can be adjusted. The heating roller 11 is heated by the same control as the returning from the power source off state of the heater 13 or the slip mode (power saving mode), without rotating the heating belt 8. In the vicinity of the boundary between a contact portion and a non-contact portion of the heating belt 8 and the heating roller 11 (in the vicinity of the contact start position β and a contact end position γ shown in FIG. 2), the temperature of the heating belt 8 when the start of the deformation of the heating belt 8 is visually confirmed is called the belt destroy temperature (heating destroy temperature) T₀ (° C.).

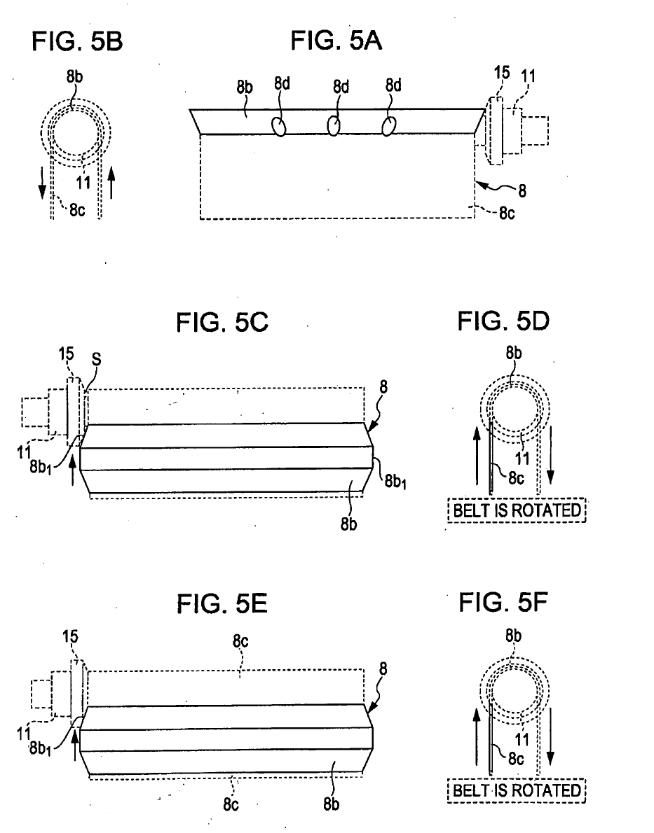

When the heating roller 11 is heated by the first mode, as shown in FIGS. 5A and 5B, a winding portion 8b of the heating belt 8 which is wound on (is in contact with) the heating roller 11 is mainly heated, but a non-winding portion 8c of the heating belt 8 which is wound on (is not in contact with) the heating roller 11 is not substantially heated. At this time, since the heating belt 8 is in a rotation stop state in the first mode, the winding portion 8b of the heating belt 8 has a relatively high temperature and the non-winding portion 8c has a relatively low temperature. Thus, a temperature difference between the winding portion 8b and the non-winding portion 8c occurs. As described above, when the mode transitions to the second mode at a time point when the wrinkles of the heating belt 8 disappear by the first mode, although the temperature difference occurs, since this temperature difference does not generate wrinkles, the heating belt 8 is smoothly rotated without receiving large pressing force from the guide ring 15.

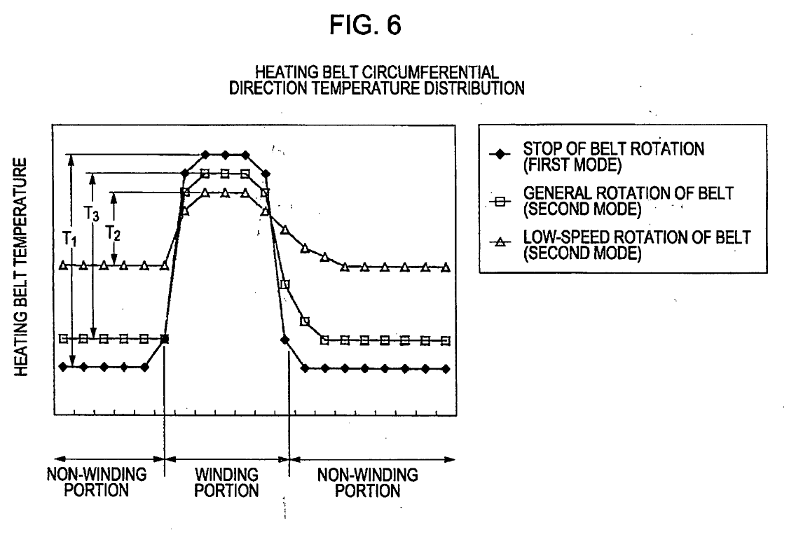

However, although the wrinkles of the heating belt 8 disappear, if the mode does not transition to the second mode, as denoted by black rhombic points of FIG. 6, a large temperature difference T₁ (° C.) occurs between the winding portion 8b and the non-winding portion 8c of the heating belt 8. Then, the winding portion 8b largely widens in the width direction, but the non-winding portion 8c does not substantially widen in the width direction. Accordingly, the widening of the winding portion 8b in the vicinity of the boundary between the winding portion 8b and the non-winding portion 8c is suppressed, and, as shown in FIG. 5A, wrinkles are generated in the vicinity of this boundary of the heating belt 8 like several convex portions 8d.

In this state, when the mode transitions to the second mode and the heating belt 8 is rotated, as shown in FIGS. 5C and 5D, the non-winding portion 8c having a relatively small width is wound on the heating belt 8. In this case, a gap s is generated between a side edge of the non-winding portion 8c and the guide surface 15a of the guide ring 15. In this state, the heating belt 8 makes one rotation and, as shown in FIG. 5C, the winding portion 8b having a relative large width is wound on the heating roller 11 again. In this case, by the rotation of the heating belt 8, as shown in FIG. 5E, the heating belt 8 is biased to one guide ring 15. Accordingly, as shown in FIGS. 5E and 5F, a side edge 8b₁ which becomes a concave portion of the winding portion 8b interferes with the guide ring 15. As a result, the side edge 8b₁ of the winding portion 8b is strongly pressed by the guide ring 15 in the width direction of the heating belt 8.

If the protrusion amount of the side edge 8b₁ of the winding portion 8b in the width direction is large, the pressing due to the guide ring 15 is increased and thus crack occurs in the heating belt 8. Even when the protrusion amount of the side edge 8b₁ of the winding portion 8b in the width direction is small and thus crack does not occur by one rotation of the heating belt 8, the heating belt 8 repeatedly receives the pressing force from the guide ring 15 by the repetition of the image formation and thus crack may occur.

Accordingly, in the fixing device 6 of this example, when the first mode transitions to the second mode and the rotation of the heating belt 8 is started, the average rotation speed of the heating belt 8 is controlled such that the temperature difference between the winding portion 8b and the non-winding portion 8c of the heating belt 8 in the first mode is decreased, until the heating belt 8 makes at least one rotation.

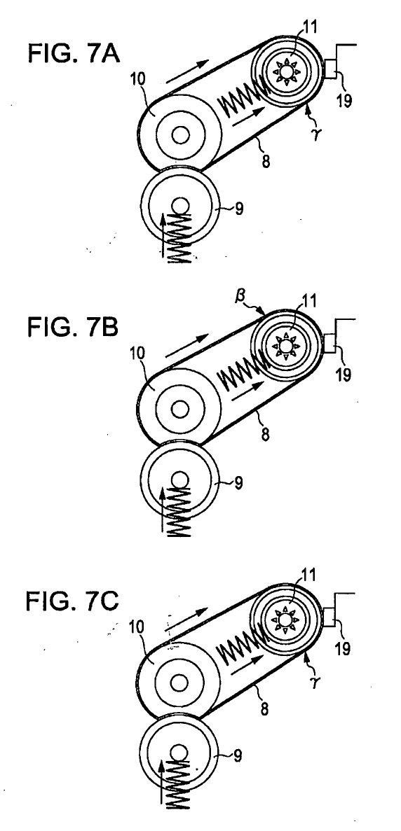

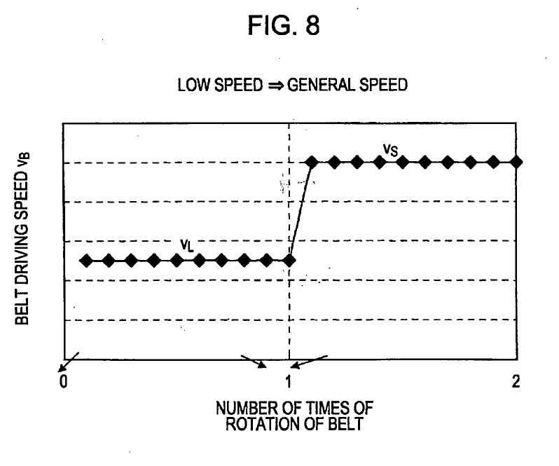

In detail, in the fixing device 6 of this example, at the time of the start of the second mode, during one rotation in which a portion of the heating belt 8 located at the contact end position γ shown in FIG. 7A passes through the contact start position β shown in FIG. 7B and returns to the contact end position γ shown in FIG. 7C, as shown in FIG. 8, a rotation speed v_{B} mm/sec of the heating belt 8 is set to a certain low rotation speed V_{L} mm/sec which is lower than a general rotation speed V_{S} mm/sec during the image formation. By the setting of the certain low rotation speed V_{L} mm/sec of the heating belt 8 at the time of the start of the second mode, during one rotation of the heating belt 8, the temperature difference between the winding portion 8b and the non-winding portion 8c in the first mode is decreased. As denoted by white triangular points of FIG. 6, the temperature difference T₂ (° C.) between the winding portion 8b and the non-winding portion 8c due to the low-speed rotation is lower than the temperature difference T₁ (° C.) during the rotation stop of the heating belt 8 of the first mode, and is significantly lower than a temperature difference T₃ (° C.) during a general rotation of the image formation denoted by white rectangular points of FIG. 6. At this time, since the low rotation speed of the heating belt 8 is constant during one rotation of the heating belt 8, the average rotation speed of the heating belt 8 is lower than the general rotation speed V_{S} mm/sec.

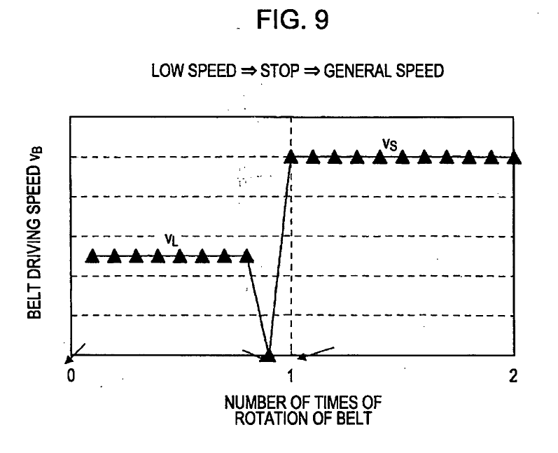

As another example in which the average rotation speed of the rotation speed V_{B} mm/sec of the heating belt 8 is lower than the general rotation speed V_{S} mm/sec at the time of the start of the second mode, as shown in FIG. 9, during one rotation of the heating belt 8 at the time of the start of the second mode, the heating belt 8 is first rotated at the certain low rotation speed V_{L} mm/sec as shown in FIG. 8. Then, when the portion of the heating belt 8 located at the contact end position γ reaches a predetermined position (for example, the contact start position β shown in FIG. 7B or the like) before one rotation, the rotation of the heating belt 8 is stopped once. Thereafter, the heating belt 8 is rotated again and the heating belt 8 is rotated at the general rotation speed V_{S} mm/sec when the heating belt 8 makes one rotation. This example shows a combination of the low rotation speed V_{L} mm/sec of the heating belt 8 and the rotation stop.

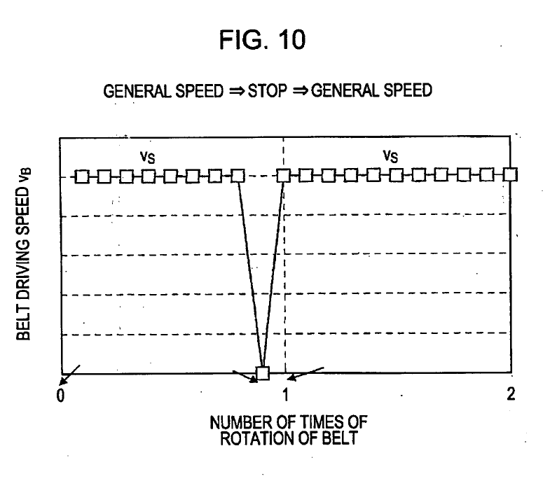

As another example in which the average rotation speed of the rotation speed V_{B} mm/sec of the heating belt 8 is lower than the general rotation speed V_{S} mm/sec at the time of the start of the second mode, as shown in FIG. 10, during one rotation of the heating belt 8 at the time of the start of the second mode, the heating belt 8 is first rotated at the general rotation speed V_{S} mm/sec. Then, when the portion of the heating belt 8 located at the contact end position γ reaches a predetermined position (for example, the contact start position β shown in FIG. 7B or the like) before one rotation, the rotation of the heating belt 8 is stopped once. Thereafter, the heating belt 8 is rotated again and the heating belt 8 is rotated at the general rotation speed V_{S} mm/sec when the heating belt 8 makes one rotation. This example shows a combination of the general rotation speed V_{S} mm/sec of the heating belt 8 and the rotation stop.

In addition, in the examples shown in FIGS. 8 to 10, the area in which the average rotation speed of the heating belt 8 during the start of the second mode is set to be lower than the general rotation speed V_{S} mm/sec is set to a rotation area of one rotation of the heating belt 8, but the area is not limited to this. This area may be set to the rotation area of at least one rotation (that is, one or more rotations) of the heating belt B.

Since the temperature difference between the winding portion 8b and the non-winding portion 8c in the first mode is decreased while the heating belt 8 makes at least one rotation after the rotation start due to the transition to the second mode, the protrusion amount of the side edge 8b₁ of the winding portion 8b in the width direction of the heating belt 8 is decreased. Accordingly, even when the heating belt 8 is rotated and the winding portion 8b enters a winding portion of the heating roller 11, the pressing force to the side edge 8b₁ of the winding portion 8b due to the guide ring 15 is decreased. Accordingly, although a large temperature difference between the winding portion 8b and the non-winding portion 8c in the first mode occurs, the generation of the crack of the heating belt 8 is suppressed.

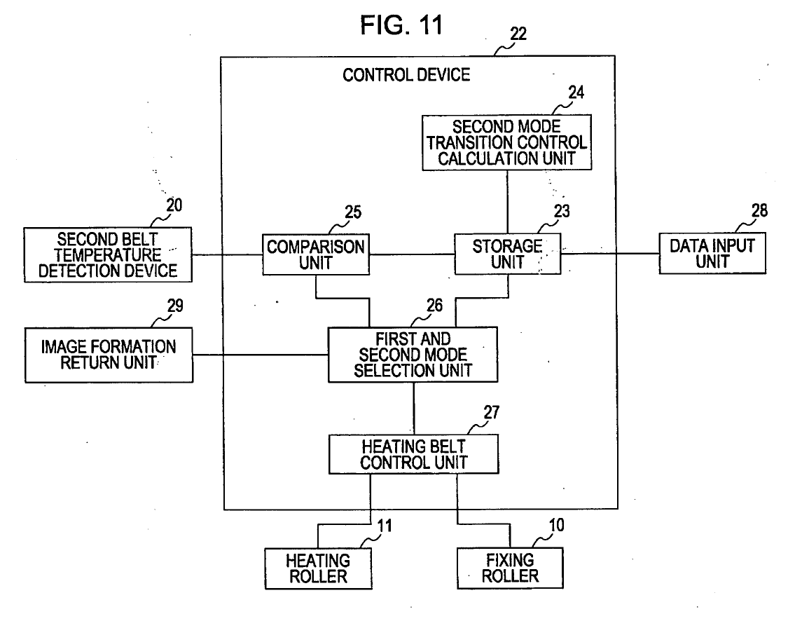

FIG. 11 is a block diagram of the control device for controlling the heating belt for image formation. As shown in FIG. 11, the control device 22 of the image forming apparatus 1 includes a storage unit 23, a second mode transition control calculation unit 24, a comparison unit 25, a first and second mode selection unit 26, and a heating belt control unit 27. The storage unit 23 is connected to a data input unit 28. When an operator such as a worker or a service man operates the data input unit 28, data is input to and stored in the storage unit 23. The data includes the width of the heating belt 8 (the distance between the guide surfaces la of the guide rings 15 of both ends of the heating roller 11) L (mm) in the fixing device 6 of the image forming apparatus 1, the belt control temperature T_{b} (° C.) of the heating belt 8 during the image forming operation, the environment temperature Tᵣ (° C.) such as a room temperature or the like of a place where this image forming apparatus 1 is used, the mode transition temperature T_{bs} (° C.) of the heating belt 8 during the transition from the first mode to the second mode, the destroy temperature T₀ (° C.) of the heating belt 8, the linear expansion coefficient αₕᵣ (1/° C.) of the heating roller 11, the linear expansion coefficient α_{b} (1/° C.) of the heating belt 8, the low rotation speed of the heating belt 8 during the start of the second mode, and the general rotation speed during the image formation. In addition, the storage unit 23 stores the control contents of the heating belt 8 in the above-described first and second modes.

The second mode transition control calculation unit 24 calculates the temperature of the left side of Equation 2. The second mode transition control calculation unit 24 sets a calculated value or a value slightly larger than this value as the mode transition reference temperature T_{bs} (° C.) of the fixing device 6 and stores the value in the storage unit 23.

The second belt temperature detection devices 20 are connected to the comparison unit 25. This comparison unit 25 compares the detected belt temperature (° C.) of the heating belt 8 detected by the second belt temperature detection devices 20 with the mode transition reference temperature T_{bs} (° C.) during the transition to the second mode of the storage unit 23. The comparison unit 25 outputs a mode switching signal to the first and second mode selection unit 26 when it is determined that the detected belt temperature (° C.) becomes equal to or larger than the mode transition reference temperature T_{bs} (° C.).

An image formation return unit 29 is connected to the first and second mode selection mode 26. This image formation return unit 29 is provided in an operating panel of the image forming apparatus 1 and is operated by, for example, a user, for image formation, so as to output a return signal for returning the image forming apparatus 1 from the power source off state or the slip mode to the first and second mode selection unit 26. At this time, the heating belt 8 has the low temperature lower than the mode transition reference temperature T_{bs} (° C.) by the power source off state or the slip mode. Accordingly, the first and second mode selection unit 26 selects the first mode of the storage unit 23 by this return signal and outputs the control contents of the first mode to the heating belt control unit 27. Then, the heating belt control unit 27 heats the heating roller 11 (that is, the heating belt 8) and holds the driving of the heating belt 8 in a stop state, according to the control contents of the first mode.

By the heating of the heating belt 8 in the first mode, the belt temperature of the heating belt 8 is increased. The belt temperature is detected and is output to the comparison unit 25. The comparison unit 25 outputs a mode switching signal to the first and second mode selection unit 26, when it is determined that the detected belt temperature from the second belt temperature detection devices 20 becomes equal to or larger than the mode transition reference temperature T_{bs} (° C.) from the storage unit 23.

Then, the first and second mode selection unit 26 selects the second mode of the storage unit 23 by this mode switching signal and outputs the control contents of the second mode to the heating belt control unit 27. Then, the heating belt control unit 27 continuously performs the heating of the heating roller 11 (that is, the heating belt 8), drives the heating belt 8, and rotates the heating belt 8, according to the control contents of the second mode. At this time, the heating belt control unit 27 sets the rotation speed of the heating belt 8 to the low rotation speed lower than the general rotation speed during the image formation, which is stored in the storage unit 23, until the heating belt 8 makes at least one rotation from the rotation stop position of the first mode. Accordingly, the heating belt 8 rotates at a speed lower than the general rotation speed during the image formation until the heating belt makes at least one rotation at the time of the transition to the second mode. Accordingly, the temperature difference between the winding portion 8b and the non-winding portion 8c of the heating belt 8 in the first mode is decreased. The rotation amount of the heating belt 8 during the transition to the second mode can be detected from the circumferential length of the heating belt 8 and the rotation speed of the heating belt 8 (that is, the rotation speed of the fixing roller 10, the rotation speed of the motor, or the like). The rotation amount of the heating belt 8 can be detected by a position detecting sensor. Alternatively, various rotation amount detecting units may be used.

At this time, since the temperatures of the heating roller 11 and the heating belt 8 are the mode transition reference temperature T_{bs} (° C.) satisfying Equations 2 and 3, the wrinkles generated in the heating belt 8 shown in FIG. 4A due to the concave portions 8a disappear as shown in FIG. 4B. Since the temperature difference between the winding portion 8b and the non-winding portion 8c of the heating belt 8 is decreased as described above, the protrusion amount of the side edge 8b₁ of the winding portion 8b in the width direction of the heating belt 8 is small. Accordingly, although the heating belt 8 is rotated, the pressing force of the width direction of the heating belt due to the guide ring 15 is decreased, the heating belt 8 is smoothly rotated, and the generation of the crack of the heating belt 8 is prevented.

By the continuous heating of the heating belt 8 in the second mode, the belt temperature of the heating belt 8 is increased. However, since the mode transition reference temperature T_{bs} (° C.) is lower than the previously measured destroy temperature T₀ (° C.) in which the heating belt 8 is thermally destroyed, the heating belt 8 is not destroyed when the mode transitions to the second mode and the heating belt 8 is rotated.

According to the fixing device 6 of this example, at the time of the returning of the heating belt 8 for the image forming operation from the low belt temperature state of the heating belt 8 due to the OFF state of the power source of the heating roller 11 in the power source off state or the slip mode (power saving mode), two modes are set with respect to the heating control and the rotation control of the heating belt 8. The first mode is a combination mode of the heating of the heating belt 8 and the rotation stop of the heating belt 8. The second mode is a combination mode of the heating of the heating belt 8 and the rotation of the heating belt 8.

Accordingly, at the time of the returning of the heating belt 8, the heating belt 8 is first heated by the setting of the first mode, but the heating belt 8 is not rotated. Next, when the surface temperature of the heating belt 8 immediately before being brought into contact with the heating roller 11 is increased to the mode transition reference temperature T_{bs}, the heating of the heating belt 8 is continuously performed and the heating belt 8 is rotated, by the setting of the second mode. At this time, the wrinkles of the heating belt 8 disappear. Accordingly, the bias of the heating belt 8 entering the heating roller 11 can be suppressed by the guide ring 15. In addition, although the guide ring 15 presses the edge of the belt portion of the heating belt 8 in the width direction, since the wrinkles are not present in the heating belt 8, it is possible to prevent the generation of the crack in the heating belt 8. Accordingly, it is possible to adequately perform the heating, the pressurization and fixing using the fixing device 6 over a long period of time.

Until the heating belt 8 makes at least one rotation at the time of the transition to the second mode, since the heating belt 8 is rotated at a low speed lower than the general rotation speed during the image formation, the temperature difference between the winding portion 8b and the non-winding portion 8c of the heating belt 8 in the first mode can be decreased. Accordingly, the protrusion amount (width step difference) of the side edge 8b₁ of the winding portion 8b in the width direction of the heating belt 8 can be decreased. Therefore, although the heating belt 8 is rotated by the second mode, the pressing force of the width direction of the heating belt due to the guide ring 15 can be decreased. As a result, the heating belt 8 can be smoothly rotated, the damage of the side edge 8b₁ of the winding portion 8b due to the guide ring 15 can be suppressed, and the generation of the crack of the heating belt 8 can be efficiently prevented. Accordingly, the long life span of the heating belt 8 can be efficiently realized. According to the image forming apparatus 1 including the fixing device 6 of this example, since the heating, the pressurization, and the fixing can be adequately performed, it is possible to form an image with high quality over a long period of time.

In the invention, a cylindrical drum may be used as the intermediate transfer medium, instead of the endless intermediate transfer belt 3. The invention is applicable to any image forming apparatus including an image forming apparatus without an intermediate transfer medium, if the fixing device 6 has the heating belt 8. The invention may be variously modified in the range described in claims.

What is claimed is:

1. A fixing device comprising: at least a heating roller, a fixing roller, a heating belt which is stretched over the heating roller and the fixing roller, is heated by the heating roller, and is rotated by a driving unit so as to fix a toner image of a transfer material, and a bias preventing unit of the heating belt provided in the heating roller,
wherein a first mode which is a combination mode of the heating of the heating belt and the rotation stop of the heating belt and a second mode which is a combination mode of the heating of the heating belt and the rotation of the heating belt are set,
at the time of returning of the heating belt for an image forming operation from non-heating and non-rotation of the heating belt, the heating belt is controlled by the first mode and the heating belt is controlled by the second mode transitioned from the first mode,
when a temperature of the heating belt becomes equal to or larger than a predetermined mode transition reference temperature, the transition from the first mode to the second is performed, and
at the time of the start of the transition to the second mode, the rotation speed of the heating belt is controlled such that a temperature difference between a winding portion of the heating belt which is wound on the heating roller and a non-winding portion of the heating belt which is not wound on the heating roller in the first mode is decreased.

2. The fixing device according to claim 1, wherein, at the start of the transition to the second mode, an average rotation speed of the heating belt is set to a low speed lower than a general rotation speed of the heating belt during image formation.

3. The fixing device according to claim 2, wherein the average rotation speed of the heating belt is a constant rotation speed lower than the general rotation speed of the heating belt during the image formation.

4. The fixing device according to claim 2, wherein the average rotation speed of the heating belt is a combination of the constant rotation speed lower than the general rotation speed of the heating belt during the image formation and the rotation stop of the heating belt.

5. The fixing device according to claim 2, wherein the low speed of the heating belt is set until the heating belt makes at least one rotation after the start of the rotation.

6. An image forming apparatus comprising: at least a latent image carrier which carries an electrostatic latent image, a development device which develops the electrostatic latent image of the latent image carrier and forms a toner image, a transfer device which transfers the toner image of the latent image carrier to a transfer material, and a fixing device which fixes the toner image of the transfer material,
wherein the fixing device is the fixing device according to claim 1,
at least a belt temperature detection device which detects the temperature of the heating belt and a control device which controls the heating of the heating belt by the heating roller and the rotation of the heating belt by the driving unit are included,
the control device includes at least a first and second mode selection unit which selects the first mode and the second mode, and a heating belt control unit which controls the heating and the rotation of the heating belt by the mode selected by the first and second mode selection unit of the first and second modes,
the first and second mode selection unit controls the heating and the rotation of the heating belt by the first mode at the time of the returning of the heating belt and controls the heating and the rotation of the heating belt by the second mode by the transition from the first mode to the second mode, and
the heating belt control unit controls the rotation speed of the heating belt such that the temperature difference between the winding portion and the non-winding portion is decreased at the time of the start of the transition to the second mode.
